(19) United States
(12) Patent Application Publication
(10) Pub. No.: US 2003/0230468 A1
(43) Pub. Date: Dec. 18, 2003

(54) Conveyor for liquid crystal panel

(76) Inventors: Ji Heum Uh, Seoul (KR); Kyung Su Chae, Taegu-Kwangyokshi (JP)

Correspondence Address: MCKENNA LONG & ALDRIDGE LLP, 1900 K STREET, NW, WASHINGTON, DC, 20006, US

(21) Appl. No.: 10/303,922

(22) Filed: Nov. 26, 2002

(30) Foreign Application Priority Data
Jun. 15, 2002 (KR) 2002-33500

(51) Int. Cl. B65G 15/10

(52) U.S. Cl. 198/817

(57) ABSTRACT

A conveyor system for conveying a liquid crystal panel includes rotating rollers. The rotating rollers include a more than one supporting end arranged along one direction and separated by a width. The rotating roller includes and at least one motor receiving to calculate data of standard requirements of the liquid crystal panel logically and numerically so as to adjust the width automatically. Therefore, the present invention enables to adjust a width between rotating rollers by automating a conveyor system.

This application claims the benefit of the Korean Application No. P2002-033500 filed on Jun. 15, 2002, which is hereby incorporated by reference for all purposes as if fully set forth herein.

### BACKGROUND OF THE INVENTION

1. Field of the Invention

The present invention relates to a conveyor system for conveying liquid crystal panels, more particularly the present invention relates to a conveyor system capable of automatically adjusting a width between supporting ends of rotating rollers.

2. Discussion of the Related Art

Generally, liquid crystal displays are devices that display images using liquid crystal cells arranged in a matrix pattern. Data signals, representative of image information, may be used to selectively control the light transmittance of each of the liquid crystal cells.

Liquid crystal displays are fabricated by forming a plurality of thin film transistor (TFT) substrates within a first substrate, forming a plurality of color filter substrates within a second substrate, bonding the first and second substrates to each other, and cutting the bonded first and second substrates into a plurality of liquid crystal panels, wherein each liquid crystal panel includes a TFT substrate bonded to a color filter substrate.

The TFT substrates are fabricated according to a process including deposition, photolithography, and etching to form an array of TFTs. The color filter substrates are fabricated according to a color filter fabricating process. The liquid crystal panels are fabricated according to a liquid crystal cell fabricating process.

Each of the TFT substrates include a plurality of gate lines arranged at fixed intervals along a first direction, and a plurality of data lines arranged at fixed intervals along a second direction, perpendicular to the first direction. Pixel areas, located at crossings of the gate and data lines, include a plurality of thin film transistors (TFTs) and pixel electrodes.

In order to prevent leakage of liquid outside the pixel areas of each of the color filter substrates, the color filter fabricating process includes a step of forming a black matrix layer in regions of the color filter substrate that do not correspond to the pixel areas. The color filter fabricating process further includes steps of forming red, green, and blue color filters, and an ITO (indium tin oxide) common electrode layer.

After the arrays of TFTs are formed, and after the color filter fabrication process is executed, the liquid crystal cell fabricating process is performed on the first and second substrates as follows.

Referring to FIG. 1, after an alignment material has been coated on the TFT and color substrate portions of the first and second substrates, respectively, an alignment process (IS) is performed on the coated alignment material to uniformly align liquid crystal material to be injected into the cell gap. The alignment process (IS) is performed by pre-cleaning each of the first and second substrates, printing the alignment layer on the TFT and color substrate portions of the first and second substrates, respectively, plasticizing the alignment layers, inspecting the alignment layers, and rubbing the alignment layers.

After the alignment process IS is completed, a gap formation process is then performed. During the gap formation process, the first and second substrates are cleaned (2S), spacers are dispensed on the first substrate so as to ensure uniformity of the cell gap (3S), sealant is dispensed on each color filter substrate within the second substrate and a liquid crystal injection inlet is formed at an edge portion of each liquid crystal panel (4S), and the first and second substrates are pressed and bonded together (5S).

The bonded first and second substrates are then cut and processed into a plurality of liquid crystal panel (6S).

Subsequently, liquid crystal material is injected through the liquid crystal injection inlet into the cell gap of each of the liquid crystal panels and the liquid crystal injection inlet is then sealed (7S).

Lastly, cut surfaces of the first and second substrates are then polished, and an exterior and electrical failure inspection is performed (8S).

The liquid crystal injection process will now be described in greater detail.

In injecting liquid crystal material, liquid crystal material is provided within a liquid crystal container, the liquid crystal container is loaded into a vacuum chamber, and pressure in the vacuum chamber is reduced, thereby creating a vacuum within the vacuum chamber so that any moisture adhered to the inner surface of the liquid crystal container or any air bubbles in the liquid crystal material are removed.

While maintaining the vacuum within the vacuum chamber, the liquid crystal injection inlet of an empty LC cell contacts, or is dipped into, the liquid crystal material in the liquid crystal container. The pressure of the vacuum chamber is then increased and, due to the pressure difference between the interior of the empty LC cell and the interior of the vacuum chamber, liquid crystal material is injected through the liquid crystal injection inlet into the cell gap.

FIG. 2 illustrates the TFT and color filter substrates 100 and 200, respectively. A plurality of gate lines 50 arranged at fixed intervals along a first direction and a plurality of data lines 60 arranged at fixed intervals along a second direction, perpendicular to the first direction, are formed on the TFT substrate. A plurality of thin film transistors (TFTs) and pixel electrodes are formed in pixel areas 70 defined by the crossing of the gate and data lines 50 and 60, respectively. A plurality of pixel areas 70 generally define an image display area 80. While not shown in FIG. 2, each of the TFTs includes gate and source electrodes formed in respective pixel areas 70 that are connected to corresponding gate and data lines 50 and 60, respectively. Drain electrodes of the TFTs are connected to corresponding to pixel electrodes arranged in corresponding pixel areas 70.

A plurality of the gate and data lines 50 and 60, respectively, are connected to gate pads and data pads 90 and 110, respectively, arranged at a periphery of the array substrate 100.

A shorting bar is provided to facilitate the inspection of the liquid crystal panels to determine if any defective characteristics were imparted to the panel during any of the aforementioned fabricating processes. The shorting bar is removed after fabrication of the liquid crystal device is complete. The shorting bar includes first to fourth sub-shorting bars 120 to 123 that are used to separately inspect odd and even data and gate lines 50 and 60, respectively. The first to fourth sub-shorting bars 120 to 123 extend toward ends of the TFT substrate such that they may couple to external terminals (not shown).

The color filter substrate 200 is slightly smaller than the TFT substrate. A black matrix layer 210 is formed on the color filter substrate 200 for preventing leakage of light in regions outside pixel areas 70. A color filter layer (not shown), common electrode (not shown), column-type spacers (not shown) may also be formed on color filter substrates used in large liquid crystal displays.

The column-type spacers arranged in correspondence with gate and data lines of the TFT substrate. A black matrix rim 220 is provided to prevent leakage of light outside the display area 80.

The TFT and color filter substrates 100 and 200, respectively, are bonded to each other using a sealant (not shown) made of photo-hardening or thermo-hardening resin.

The substrates (e.g., bonded TFT and color filter substrates, bonded first and second substrates, unbonded first and second substrates, etc.) are transported between various fabricating processes (e.g., grinding processes, cleaning processes, etc.) via a variable width conveyor system.

Conveyors systems, such as those illustrated in FIG. 3, include a plurality of rotating rollers 300 having supporting ends 300A spaced apart from each other by a predetermined width. The rotating rollers 300 rotate to convey substrates 100A from one location to another. Edges of the substrates 100A are arranged on and contact supporting ends 300A of the rotating roller 300. The substrates 100A are transported according to the electrical characteristics of the panel area of liquid crystal panels. Static electricity may be generated due to friction caused by contact between the liquid crystal panels and the supporting ends 300A. Accordingly, supporting ends 300A are arranged to contact edges of the liquid crystal panels that include the gate pads or data pads 90 or 110, respectively, and the black matrix rim 220 to thereby minimize the risk of generating static electricity.

Conveyor systems such as those illustrated in FIG. 3, however, are disadvantageous for the following reasons.

During the liquid crystal cell fabricating process, the width between the supporting ends 300A must be optimally adjusted to efficiently transport liquid crystal panels. To adjust the width between the supporting ends 300A, a screw (not shown) is manually turned. In manually turning the screw, the efficiency of the conveyor system is reduced.

Moreover, upon manually turning the screw, the width may be incorrectly adjusted and one of the supporting ends 300A may contact the unit liquid crystal panels in a manner capable of generating static electricity. Static electricity damages the alignment layer and degrades the injected liquid crystal material.

### SUMMARY OF THE INVENTION

Accordingly, the present invention is directed to a conveyor system for liquid crystal panels that substantially obviates one or more problems due to limitations and disadvantages of the related art.

An advantage of the present invention provides a conveyor for liquid crystal panels capable of automatically adjusting a width between supporting ends of rotating rollers.

Additional advantages and features of the invention will be set forth in part in the description which follows and in part will become apparent to those having ordinary skill in the art upon examination of the following or may be learned from practice of the invention. These and other advantages of the invention may be realized and attained by the structure particularly pointed out in the written description and claims hereof as well as the appended drawings.

To achieve these and other advantages and in accordance with the purpose of the invention, as embodied and broadly described herein, a conveyor system for a liquid crystal panel includes rotating rollers having a pair of supporting ends arranged along a direction and separated by a predetermined width and least one motor for receiving data related to the liquid crystal panel and for automatically adjusting the predetermined width.

In one aspect of the present invention, the predetermined width may be adjusted such that edge areas of the liquid crystal panel are continuously arranged on the supporting ends of the rotating rollers.

In another aspect of the present invention, the edge areas of the liquid crystal panel may include pads and black matrix areas.

In yet another aspect of the present invention, the motor may include a servo-motor.

It is to be understood that both the foregoing general description and the following detailed description of the present invention are exemplary and explanatory and are intended to provide further explanation of the invention as claimed.

### BRIEF DESCRIPTION OF THE DRAWINGS

The accompanying drawings, which are included to provide a further understanding of the invention and are incorporated in and constitute a part of this application, illustrate embodiment(s) of the invention and together with the description serve to explain the principle of the invention.

In the drawings:

FIG. 1 illustrates a flowchart of a liquid crystal display fabrication method incorporating liquid crystal injection technique;

FIG. 2 illustrates a schematic view of a liquid crystal panel;

FIG. 3 illustrates a perspective view of a conveyor system for conveying a liquid crystal panel; and

FIG. 4 illustrates a front view of a conveyor system for conveying a liquid crystal panel according to the present invention.

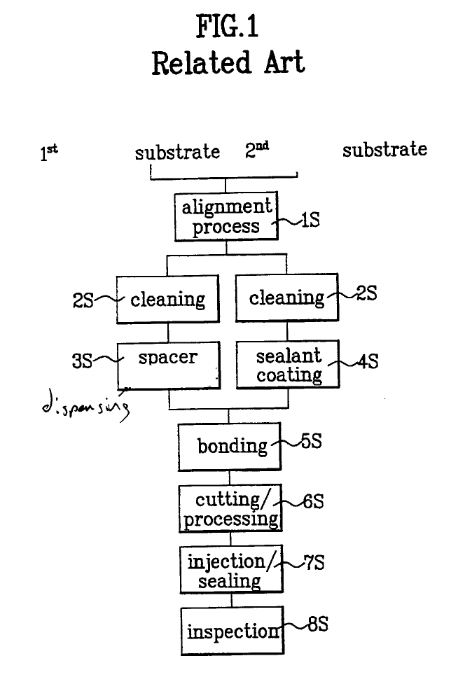

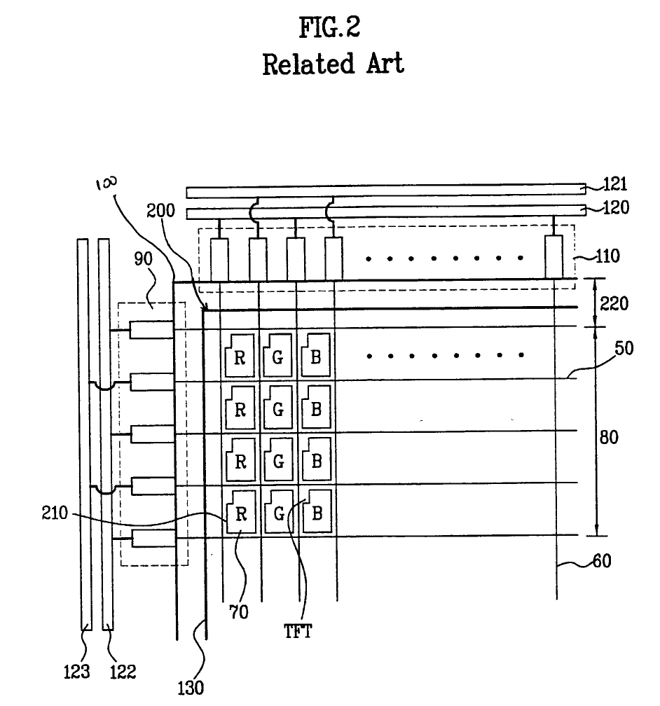

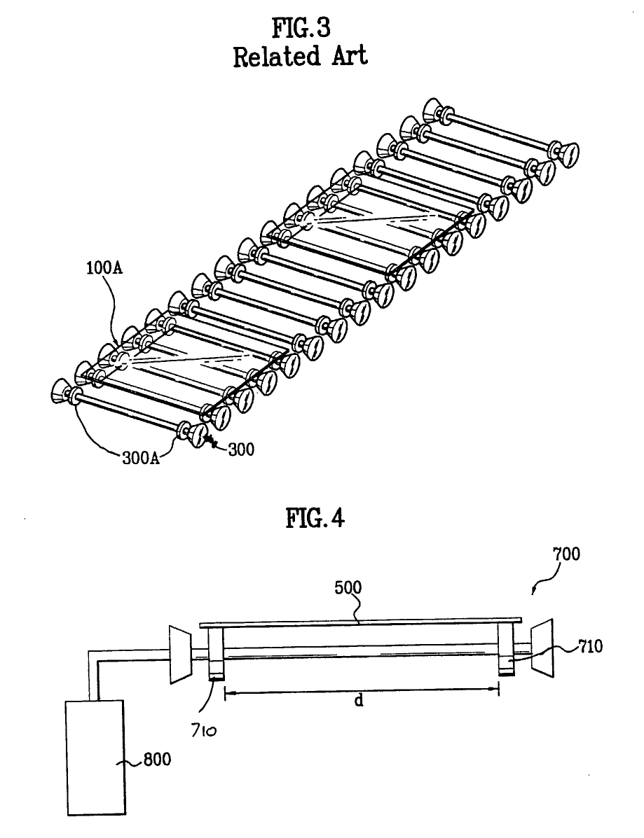

### DETAILED DESCRIPTION OF THE ILLUSTRATED EMBODIMENTS

Reference will now be made in detail to embodiments of the present invention, examples of which are illustrated in the accompanying drawings. Wherever possible, the same reference numbers will be used throughout the drawings to refer to the same or like parts.

FIG. 4 illustrates a front view of a conveyor of a conveyor system for conveying a liquid crystal panel, according to the present invention.

Referring to FIG. 4, a a liquid crystal panel 500, including TFT and color filter substrates bonded to each other, may be arranged on a rotating roller 700 of a conveyor system.

In one aspect of the present invention, the liquid crystal panel may prepared by injecting liquid crystal material between first and second substrate including TFT and color filter substrates, respectively, and cutting the injected first and second substrates (e.g., using a cutting wheel).

In one aspect of the present invention, the cutting wheel may comprise a material having a hardness higher than that of glass (e.g., diamond) and include blades may formed along a periphery of front and rear faces.

The cutting wheel may be closely held to the bonded substrates using a uniform pressure. Upon rotating, the cutting wheel forms a groove in the bonded substrates to predetermined depth. After the groove has been formed, a crack may be propagated downward by impacting the bonded substrates. Accordingly, a plurality of liquid crystal panels 500 may thereby be formed from the bonded substrates.

Referring to FIG. 4, the liquid crystal panel 500 may be transported using a conveyor system that includes at least one rotating roller 700. Accordingly, the rotating roller may be used to convey the liquid crystal panel 500 to a location where an inspection may be performed to evaluate the presence of burrs, or other imperfections, on sides of the liquid crystal panel 500 (e.g., the side including the data pad, the side including gate pad, or any other sides).

In one aspect of the present invention, the rotating roller 700 may include a plurality of supporting ends 710 arranged along one direction and separated by a width, d, to transport the liquid crystal panel 500. The width, d, may be adjusted in accordance with requirements of the liquid crystal panel 500 such that edges of the liquid crystal panel 500 continuously contact the supporting ends 710.

Accordingly, adjustment of the width, d, may be required and automatically achieved using at least one servomotor 800 arranged at a side of the rotating roller 700. In one aspect of the present invention, the servo-motor 800 may receive data related to the liquid crystal panel and logically and numerically determine the orientation of the supporting ends 710.

In one aspect of the present invention, the servomotor 800 may automatically adjust the position, direction, orientation, and the like, of the each of the supporting ends 710 in proportion to a random variance of an input target value. The servo system may include a high-precision servo-mechanism such as a numerical controller of an operation machine, a data floater of a digital calculator output, and the like.

In one aspect of the present invention, the servomotor 800 may be coupled to the rotating roller 700 to improve the operational productivity of the rotating roller 700 and thus conveyor system. Accordingly, the servo-motor may reduce time required for retooling, maintaining a continuous conveyance of liquid crystal panels, and simplify various fabricating processes (e.g., grinding, cleaning cut sides of panels, etc.) that are involved in conveyance of the liquid crystal panel.

According to the principles of the present invention, the rotating roller 700 facilitating the conveyance of liquid crystal panels is advantageous for the following reasons.

The present invention may include a servo-motor arranged at a side of the conveyor for numerically and logically calculating the dimensions of liquid crystal panels, thereby enabling the automatic adjustment of the width between supporting ends or rotating rollers. By automatically adjusting the width of the supporting ends, the supporting ends 710 may be provided to continuously contact edge portions of the liquid crystal panels. As the edge portions include gate pad, data pad, and black matrix structures, the risk of generating static electricity in the liquid crystal panel, upon conveyance of the liquid crystal, may be minimized.

It will be apparent to those skilled in the art that various modifications and variations can be made in the present invention. Thus, it is intended that the present invention covers the modifications and variations of this invention provided they come within the scope of the appended claims and their equivalents.

What is claimed is:

1. A conveyor system, comprising:
at least one rotating roller including a pair of supporting ends arranged along one direction and spaced apart from each other by a width; and
at least one motor for receiving data related to the dimensions of the a liquid crystal panel and for automatically adjusting the width.

2. The conveyor system of claim 1, wherein the liquid crystal panel comprises:
an upper substrate;
a lower substrate bonded to the upper substrate; and
liquid crystal material arranged between the upper and lower substrates.

3. The conveyor system of claim 2, wherein the lower substrate comprises:
a plurality of gate lines arranged in fixed intervals along a first direction;
a plurality of data lines arranged in fixed intervals along a second direction, perpendicular to the first direction;
a plurality of pixel areas arranged at crossings of the plurality of gate lines and the plurality of data lines, the plurality of pixel areas including plurality of thin film transistors and pixel electrodes; and
gate pads and data pads formed at an edge of the lower substrate so as to be connected to the gate and data lines, respectively.

4. The conveyor system of claim 3, the upper substrate comprising:
a black matrix layer for preventing leakage of light outside the pixel areas;
a color filter layer; and
a common electrode for driving the liquid crystal panel.

5. The conveyor system of claim 4, wherein the width is automatically adjustable to correspond with edge areas of the liquid crystal panel.

6. The conveyor system of claim 5, wherein the edge areas of the liquid crystal panel include portions of the liquid crystal panel including a pad and black matrix layer.

7. The conveyor system of claim 1, wherein the motor is a servo-motor.

8. The conveyor system of claim 1, wherein the motor adjusts the width by causing at least one of the supporting ends to be moved.

9. A rotating roller, comprising:
more than one supporting end for contacting and supporting an object at a predetermined area; and
a motor for automatically adjusting a distance between the more than one supporting end.

10. The rotating roller according to claim 9, wherein the object includes a liquid crystal display panel.

11. The rotating roller according to claim 9, wherein the predetermined area corresponds to a area where generation of static electricity in the object may be minimized.

12. The rotating roller according to claim 9, wherein motor includes a servo-motor.

13. The rotating roller according to claim 9, wherein the object includes a liquid crystal panel.

14. The rotating roller according to claim 9, wherein the predetermined area includes a gate pad.

15. The rotating roller according to claim 9, wherein the predetermined area includes a data pad.

16. The rotating roller according to claim 9, wherein the predetermined area includes a black matrix layer.

17. The rotating roller according to claim 9, wherein the motor adjusts the distance by causing at least one of the supporting ends to be moved.
